(19) United States
(12) Patent Application Publication
(10) Pub. No.: US 2026/0299707 A1
(43) Pub. Date: Oct. 1, 2026

(54) METHOD FOR CONTROLLING DISPLAY SYSTEM, NON-TRANSITORY COMPUTER-READABLE STORAGE MEDIUM STORING PROGRAM FOR CONTROLLING DISPLAY SYSTEM, AND DISPLAY SYSTEM

(71) Applicant: SEIKO EPSON CORPORATION, Tokyo (JP)

(72) Inventor: Susumu OTA, Matsumoto-shi (JP)

(73) Assignee: SEIKO EPSON CORPORATION, Tokyo (JP)

(21) Appl. No.: 19/629,881

(22) Filed: Mar. 26, 2026

(30) Foreign Application Priority Data
Mar. 27, 2025 (JP) 2025-053186

(51) Int. Cl. G06F 3/02; G06F 3/0354; G06F 3/038; H04N 9/31

(52) U.S. Cl. CPC G06F 3/0227; G06F 3/03545; G06F 3/0383; H04N 9/3179

(57) ABSTRACT

A method for controlling a display system includes: transmitting video data from an information terminal apparatus to a display apparatus; projecting a video onto a projection receiving surface via the display apparatus based on the video data; acquiring, via the display apparatus, one or more shortcut keys used to control reproduction of the video, the one or more shortcut keys corresponding to an application configured to control the video in the information terminal apparatus; transmitting any one of the one or more shortcut keys from the display apparatus to the information terminal apparatus; and controlling the video based on the one shortcut key received by the information terminal apparatus.

The present application is based on, and claims priority from JP Application Serial Number 2025-053186, filed Mar. 27, 2025, the disclosure of which is hereby incorporated by reference herein in its entirety.

### BACKGROUND

### 1. Technical Field

The present disclosure relates to a method for controlling a display system, a non-transitory computer-readable storage medium storing a program for controlling a display system, and a display system.

### 2. Related Art

There is a technology of related art used to display a predetermined image corresponding to a user's writing operation on a projection receiving surface via a display apparatus that projects an image onto the projection receiving surface.

For example, in the technology described in JP-A-2013-089987, a display apparatus stores a table in which a control mark indicating a reproduction mode of an interactive image is associated with control information that is information indicating the reproduction mode of the interactive image. When a user writes the control mark on a whiteboard, the display apparatus controls the reproduction mode of the interactive image projected onto the whiteboard by using the control information corresponding to the written control mark.

JP-A-2013-089987 is an example of the related art.

JP-A-2013-089987 describes how to stop reproducing a video, but does not describe a detailed control method. In addition, it has not been considered in JP-A-2013-089987 that an information terminal apparatus uses various video applications to reproduce a video.

More specifically, there are various types of video applications that reproduce a video on an information terminal apparatus, and shortcut keys used to specify the reproduction mode of a video also differ on a video application basis. There is therefore a problem in terms of determination of a method for controlling the information terminal apparatus via the display apparatus by only using the table in which the control mark and the control information are merely associated with each other, as in the technology according to JP-A-2013-089987.

### SUMMARY

A method for controlling a display system according to an aspect of the present disclosure is a method for controlling a display system including an information terminal apparatus and a display apparatus configured to communicate with the information terminal apparatus, and the method includes: transmitting video data from the information terminal apparatus to the display apparatus; projecting a video onto a projection receiving surface via the display apparatus based on the video data; acquiring, via the display apparatus, one or more shortcut keys used to control reproduction of the video, the one or more shortcut keys corresponding to an application configured to control the video in the information terminal apparatus; transmitting any one of the one or more shortcut keys from the display apparatus to the information terminal apparatus; and controlling the video based on the one shortcut key received by the information terminal apparatus.

A non-transitory computer-readable storage medium storing a program configured to control a display system according to another aspect of the present disclosure is a non-transitory computer-readable storage medium storing a program configured to control a display system including an information terminal apparatus and a display apparatus configured to communicate with the information terminal apparatus, and the program causes the information terminal apparatus to transmit video data to the display apparatus; causes the display apparatus to project a video onto a projection receiving surface based on the video data; causes the display apparatus to acquire one or more shortcut keys used to control reproduction of the video, the one or more shortcut keys corresponding to an application configured to control the video in the information terminal apparatus; causes the display apparatus to transmit any one of the one or more shortcut keys to the information terminal apparatus; and causes the information terminal apparatus to control the video based on the received one shortcut key.

A display system according to another aspect of the present disclosure is a display system including: an information terminal apparatus; and a display apparatus configured to communicate with the information terminal apparatus, the information terminal apparatus including a communication control unit configured to transmit video data to the display apparatus, the display apparatus including a projection control unit configured to project a video onto a projection receiving surface based on the video data, the display apparatus includes an acquisition unit configured to acquire one or more shortcut keys used to control reproduction of the video, the one or more shortcut keys corresponding to an application configured to control the video in the information terminal apparatus, the display apparatus includes a communication control unit configured to transmit any one of the one or more shortcut keys acquired by the acquisition unit to the information terminal apparatus, and the information terminal apparatus including a video control unit configured to control the video based on the one shortcut key received from the display apparatus.

### BRIEF DESCRIPTION OF THE DRAWINGS

FIG. 1 is a block diagram showing an overall configuration of a display system.

FIG. 2 is a block diagram showing an example of the configuration of an information terminal apparatus.

FIG. 3 is a table showing an example of the configuration of a shortcut key database.

FIG. 4 is a block diagram showing an example of the configuration of a display apparatus.

FIG. 5 is an example of the exterior of a first input apparatus.

FIG. 6 shows an example of an image displayed on a projection receiving surface.

FIG. 7 shows an example of the image displayed on the projection receiving surface.

FIG. 8 shows an example of the image displayed on the projection receiving surface.

FIG. 9 shows an example of the image displayed on the projection receiving surface.

FIG. 10 is a sequence diagram showing the operation of the display system.

FIG. 11 is a block diagram showing an example of the configuration of the information terminal apparatus.

FIG. 12 is a block diagram showing an example of the configuration of the display apparatus.

FIG. 13 is a sequence diagram showing the operation of the display system.

### DESCRIPTION OF EMBODIMENTS

A display method, an information processing apparatus, and a non-transitory computer-readable storage medium storing a program according to embodiments will be described below with reference to the drawings. Note in the drawings that the dimensions and scale of each portion differ from actual values as appropriate. The embodiments described below are preferable specific examples, and various technically preferable restrictions are therefore imposed thereon. However, the scope of the present disclosure is not limited to the embodiments unless the following description particularly limits the present disclosure.

### 1: First embodiment

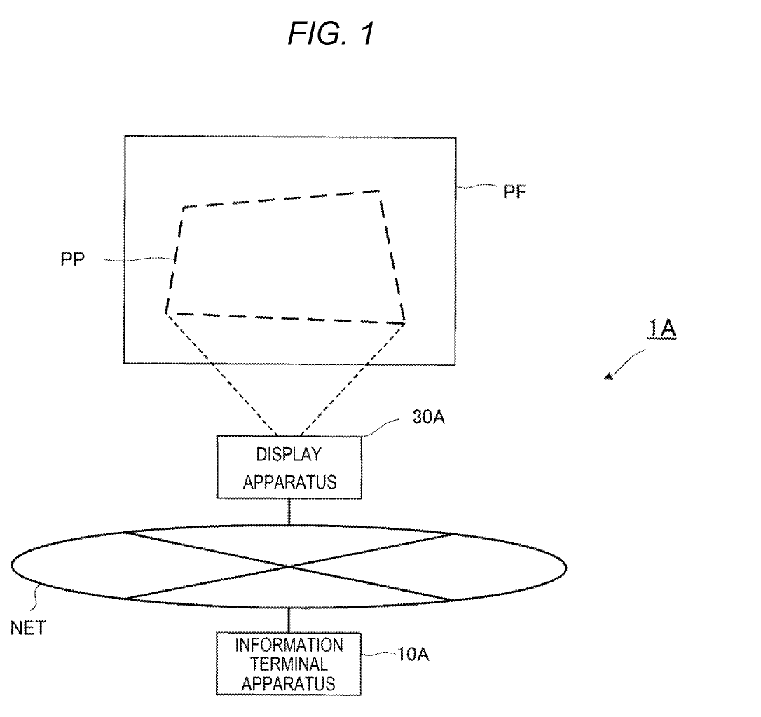

A display system 1A according to a first embodiment will be described below with reference to FIGS. 1 to 10.

### 1-1: Configuration of first embodiment

### 1-1-1: Overall configuration

FIG. 1 is a block diagram showing an overall configuration of the display system 1A according to the present embodiment. The display system 1A includes an information terminal apparatus 10A and a display apparatus 30A.

In the display system 1A shown in FIG. 1, the information terminal apparatus 10A and the display apparatus 30A are connected to each other in a communicable manner via a communication network NET.

The display apparatus 30A is, for example, a projection apparatus including a projector 31, which will be described later. The display apparatus 30A projects a projection image PP onto a projection receiving surface PF. The projection receiving surface PF is, for example, a wall or a screen.

The information terminal apparatus 10A is a server that manages the display apparatus 30A. More specifically, as an example, the information terminal apparatus 10A supplies the display apparatus 30A with an image to be projected by the display apparatus 30A onto the projection receiving surface PF. The information terminal apparatus 10A is, for example, a personal computer (PC), a tablet, or a smartphone.

### 1-1-2: Configuration of information terminal apparatus

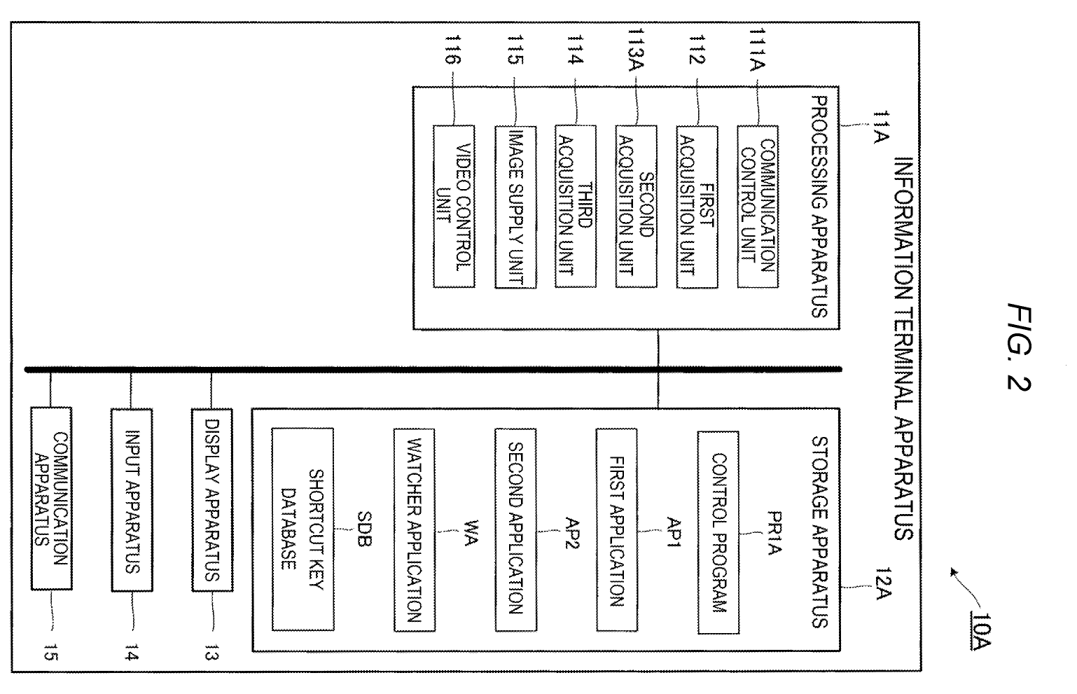

FIG. 2 is a block diagram showing an example of the configuration of the information terminal apparatus 10A. The information terminal apparatus 10A is typically a PC, a tablet, or a smartphone as described above, but is not limited thereto. The information terminal apparatus 10A includes a processing apparatus 11A, a storage apparatus 12A, a display apparatus 13, an input apparatus 14, and a communication apparatus 15. The processing apparatus 11A, the storage apparatus 12A, the display apparatus 13, the input apparatus 14, and the communication apparatus 15 are connected to each other via a single bus or multiple buses for information communication.

The processing apparatus 11A is a processor that controls the entire information terminal apparatus 10A, and is configured, for example, with one or more chips. The processing apparatus 11A includes, for example, a central processing unit (CPU) including an interface with peripheral apparatuses, an arithmetic operation unit, a register, and other elements. Note that some or all of the functions of the processing apparatus 11A may be realized by hardware such as a digital signal processor (DSP), an application specific integrated circuit (ASIC), a programmable logic device (PLD), or a field programmable gate array (FPGA). The processing apparatus 11A performs various types of processing in parallel or in sequence.

The storage apparatus 12A is a recording medium readable and writable via the processing apparatus 11A, and stores multiple programs including a control program PR1A to be executed by the processing apparatus 11A. The storage apparatus 12A further stores a compiler language program describing a procedure of arithmetic operation executed by the processing apparatus 11A.

The storage apparatus 12A still further stores a first application AP1, a second application AP2, a watcher application WA, and a shortcut key database SDB.

The first application AP1 is an application executed by the information terminal apparatus 10A. During the execution of the first application AP1, the information terminal apparatus 10A supplies the display apparatus 30A with a video MV, and controls reproduction of the video MV on the display apparatus 30A based on an input from the input apparatus 14, which will be described later.

The second application AP2 is an application executed by the information terminal apparatus 10A, as the first application AP1. During the execution of the second application AP2, the information terminal apparatus 10A supplies the display apparatus 30A with the video MV, and controls reproduction of the video MV on the display apparatus 30A based on an input from the input apparatus 14, which will be described later.

As an example, note that information on the input inputted to the input apparatus 14 to control the reproduction of the video MV on the display apparatus 30A during the execution of the first application AP1 and information on the input inputted to the input apparatus 14 to control the reproduction of the video MV on the display apparatus 30A during the execution of the second application AP2 differ from each other even when the two pieces of information are input information for the same control.

In the present embodiment, as an example, a shortcut key inputted to the input apparatus 14 to control the reproduction of the video MV on the display apparatus 30A during the execution of the first application AP1 differs from a shortcut key inputted to the input apparatus 14 to control the reproduction of the video MV on the display apparatus 30A during the execution of the second application AP2.

In the description below, as an example, it is assumed that a shortcut key used to pause the reproduction of the video MV on the display apparatus 30A during the execution of the first application AP1 is the "Enter" key, and that a shortcut key used to reproduce the video MV or resume the reproduction is the "Space" key. Furthermore, as an example, it is assumed that a shortcut key used to pause the reproduction of the video MV on the display apparatus 30A during the execution of the second application AP2 is the "X" key, and that a shortcut key used to reproduce the video MV or resume the reproduction is the "Y" key.

The watcher application WA watches which application AP is activated, the first application AP1 or the second application AP2. Note in the present embodiment that out of a projection image PP1 displayed on the projection receiving surface PF in accordance with the first application AP1 and a projection image PP2 displayed on the projection receiving surface PF in accordance with the second application AP2, the projection image PP corresponding to the activated application AP is displayed as a forefront image on the projection receiving surface PF. In the present specification, the activation indicates activation of a window for the application AP.

When the first application AP1 is activated, the watcher application WA acquires, from the first application AP1, information indicating a shortcut key used to control the reproduction of the video MV on the display apparatus 30A during the execution of the first application AP1. The control of the reproduction of the video MV includes pausing the reproduction of the video MV and reproducing the video MV or resuming the reproduction. The watcher application WA further acquires information on the attributes of the first application AP1 from the first application AP1. The attribute information contains identification information used to identify the first application AP1. The identification information indicates, as an example, the application name of the first application AP1. As an example, it is assumed in the description that the application name of the first application AP1 is "ap1". The information on the attributes of the first application AP1 contains the version of the first application AP1, and information indicating whether the PC on which the first application AP1 runs operates in accordance with Mac (registered trademark) or Windows (registered trademark).

Similarly, when the second application AP2 is activated, the watcher application WA acquires, from the second application AP2, information indicating a shortcut key used to control the reproduction of the video MV on the display apparatus 30A during the execution of the second application AP2. The control of the reproduction of the video MV includes pausing the reproduction of the video MV and reproducing the video MV or resuming the reproduction. The watcher application WA further acquires information on the attributes of the second application AP2 from the second application AP2. The attribute information contains identification information used to identify the second application AP2. The identification information indicates, as an example, the application name of the second application AP2. As an example, it is assumed in the description that the application name of the second application AP2 is "ap2". The information on the attributes of the second application AP2 contains the version of the second application AP2, and information indicating whether the PC on which the second application AP2 runs operates in accordance with Mac or Windows.

The shortcut key database SDB stores information indicating shortcut keys used to control the video MV in the first application AP1 and the second application AP2.

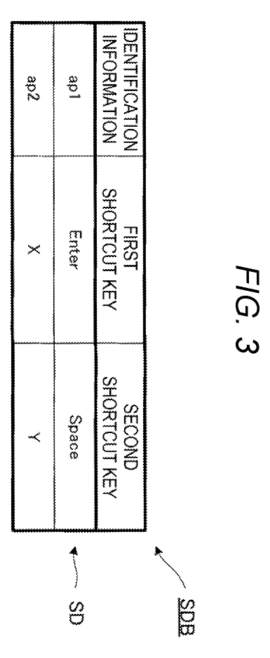

FIG. 3 is a table showing an example of the configuration of the shortcut key database SDB. The shortcut key database SDB stores shortcut key data SD acquired by the watcher application WA described above from each of the first application AP1 and the second application AP2. The shortcut key data SD includes the following items: "identification information"; "first shortcut key"; and "second shortcut key".

The "identification information" is information used to identify the application AP installed in the information terminal apparatus 10A. In the example shown in FIG. 3, the name of the application AP is used as the "identification information".

The "first shortcut key" is information indicating a first shortcut key used to control the reproduction of the video MV on the display apparatus 30A during the execution of the application AP indicated by the "identification information". As an example, the first shortcut key is a key used to pause the reproduction of the video MV.

The "second shortcut key" is information indicating a second shortcut key used to control the reproduction of the video MV on the display apparatus 30A during the execution of the application AP indicated by the "identification information". As an example, the second shortcut key is a key used to reproduce the video MV or resume the reproduction.

In the example shown in FIG. 3, as an example, the shortcut key database SDB stores the shortcut key data SD indicating that the "identification information" is "ap1", the "first shortcut key" is "Enter", and the "second shortcut key" is "Space".

In FIG. 2, the storage apparatus 12A may further store an image supplied to the display apparatus 30A by the information terminal apparatus 10A. The image includes the video MV.

The storage apparatus 12A may be configured, for example, with at least one of a read only memory (ROM), an erasable programmable ROM (EPROM), an electrically erasable programmable ROM (EEPROM), and a random access memory (RAM). The storage apparatus 12A may be called a register, a cache, a main memory, a main storage apparatus, or the like.

The display apparatus 13 is a device that displays an image or character information. The display apparatus 13 may be a display device separate from the other elements of the information terminal apparatus 10A.

The input apparatus 14 is an instrument that accepts an operation from the user of the information terminal apparatus 10A. For example, the input apparatus 14 includes a pointing device such as a keyboard, a touch pad, a touch panel, or a mouse. When the input apparatus 14 includes a touch panel, the input apparatus 14 may also serve as the display apparatus 13.

The communication apparatus 15 is hardware serving as a transmission and reception device to communicate with other apparatuses. The communication apparatus 15 is also called, for example, a network device, a network controller, a network card, or a communication module. The communication apparatus 15 may include a connector for wired connection and an interface circuit corresponding to the connector. The communication apparatus 15 may include a wireless communication interface. Examples of the connector for wired connection and the interface circuit may include those that conform to a wired LAN, IEEE 1394, and USB. Examples of the wireless communication interface may include those that conform to a wireless LAN, Bluetooth (registered trademark), and the like.

The processing apparatus 11A reads the control program PR1A from the storage apparatus 12A and executes the program to function as a communication control unit 111A, a first acquisition unit 112, a second acquisition unit 113A, a third acquisition unit 114, an image supply unit 115, and a video control unit 116.

The communication control unit 111A controls the communication apparatus 15 to cause the communication apparatus 15 to transmit and receive various pieces of information, data, and signals to and from external apparatuses. The external apparatuses include the display apparatus 30A.

The first acquisition unit 112 acquires an image to be supplied to the display apparatus 30A from the storage apparatus 12A or an apparatus external to the information terminal apparatus 10A. The image includes the video MV, as described above.

The second acquisition unit 113A acquires the identification information of the activated application AP from the watcher application WA.

The third acquisition unit 114 refers to the shortcut key database SDB by using the identification information acquired by the second acquisition unit 113A to acquire a shortcut key group corresponding to the identification information.

As an example, when the identification information acquired by the second acquisition unit 113A is "ap1", the third acquisition unit 114 acquires a shortcut key group including "Enter" as the "first shortcut key" and "Space" as the "second shortcut key".

The shortcut key group acquired by the third acquisition unit 114 is transmitted to the display apparatus 30A by the communication control unit 111A.

Specifically, the communication control unit 111A transmits information indicating a shortcut key used to control the reproduction of the video MV on the display apparatus 30A during the execution of the first application AP1 to the display apparatus 30A during the period for which the first application AP1 is kept activated.

Similarly, the communication control unit 111A transmits information indicating a shortcut key used to control the reproduction of the video MV on the display apparatus 30A during the execution of the second application AP2 to the display apparatus 30A during the period for which the second application AP2 is kept activated.

The image supply unit 115 supplies the display apparatus 30A with image data indicating the image acquired by the first acquisition unit 112. The image includes the video MV, as described above.

The video control unit 116 controls the reproduction of the video MV on the display apparatus 30A based on the input information from the input apparatus 14.

Specifically, during the execution of the first application AP1, the video control unit 116 controls the reproduction of the video MV on the display apparatus 30A based on the input information corresponding to the first application AP1.

Similarly, during the execution of the second application AP2, the video control unit 116 controls the reproduction of the video MV on the display apparatus 30A based on the input information corresponding to the second application AP2.

### 1-1-3: Configuration of display apparatus

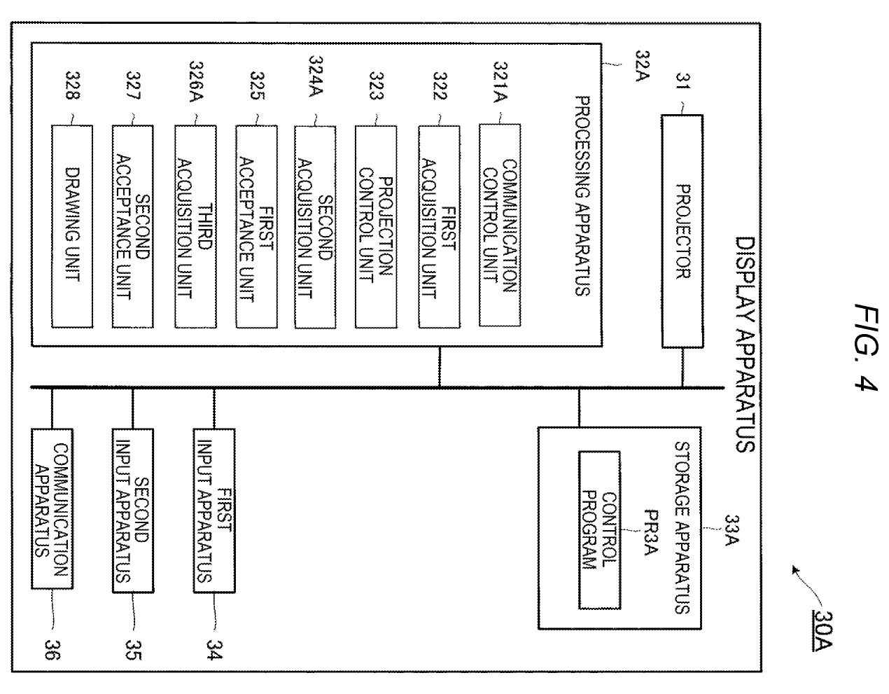

FIG. 4 is a block diagram showing an example of the configuration of the display apparatus 30A.

The display apparatus 30A includes a projector 31, a processing apparatus 32A, a storage apparatus 33A, a first input apparatus 34, a second input apparatus 35, and a communication apparatus 36. The following elements are connected to each other via a single bus or multiple buses for information communication: the projector 31; the processing apparatus 32A; the storage apparatus 33A; the first input apparatus 34; the second input apparatus 35; and the communication apparatus 36. The elements of the display apparatus 30A are each configured with one or more instruments, and some of the elements of the display apparatus 30A may be omitted.

The projector 31 projects various images under the control of the processing apparatus 32A. The projector 31 is an apparatus that projects, as the projection image PP, an acquired image acquired from the information terminal apparatus 10A by a first acquisition unit 322, which will be described later, and a drawn image DI generated by a drawing unit 328, which will be described later, onto the projection receiving surface PF. The acquired image and the drawn image DI are superimposed on each other and displayed on the projection receiving surface PF. Note that the function of superimposing the acquired image acquired from the information terminal apparatus 10A and the drawn image DI generated by the drawing unit 328 on each other and displaying the superimposed image on the projection receiving surface PF is referred to as an "annotation function" in the present specification.

The acquired image acquired from the information terminal apparatus 10A includes the video MV, as described above.

The projector 31 includes, for example, a light source, a liquid crystal panel, and a projection lens, modulates light from the light source with the liquid crystal panel, and projects the modulated light onto a screen, a wall, or the like via the projection lens. The liquid crystal panel is an example of a light modulator.

The processing apparatus 32A includes one or more processors that control the entire display apparatus 30A and is configured with, for example, one or more chips. The processing apparatus 32A is configured, for example, with a central processing unit (CPU) including an interface with peripheral apparatuses, an arithmetic operation unit, a register, and the like. Note that some or all of the functions of the processing apparatus 32A may be realized by hardware such as a DSP, an ASIC, a PLD, or an FPGA. The processing apparatus 32A performs various types of processing in parallel or in sequence.

The storage apparatus 33A is a recording medium readable via the processing apparatus 32A, and stores multiple programs including a control program PR3A to be executed by the processing apparatus 32A. The storage apparatus 33A further stores a compiler language program describing a procedure of arithmetic operation executed by the processing apparatus 32A.

The storage apparatus 33A may further store the projection image PP to be projected by the display apparatus 30A.

The storage apparatus 33A may be configured, for example, with at least one of a ROM, an EPROM, an EEPROM, and a RAM. The storage apparatus 33A may be called a register, a cache, a main memory, a main storage apparatus, or the like.

The first input apparatus 34 is an apparatus that inputs a start signal of the annotation function described above and a stop signal of the annotation function to the processing apparatus 32A. The first input apparatus 34 is, for example, a remote control.

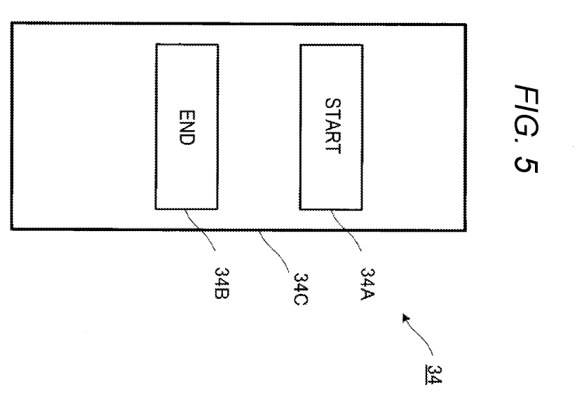

FIG. 5 is an example of the exterior of the first input apparatus 34. The first input apparatus 34 includes a first button 34A, a second button 34B, and an enclosure 34C. The first button 34A is a button used to input the start signal of the annotation function to the processing apparatus 32A. The second button 34B is a button used to input the stop signal of the annotation function to the processing apparatus 32A. The first button 34A and the second button 34B are provided at a surface of the enclosure 34C. The user of the display apparatus 30A starts the annotation function by operating the first button 34A. The user stops the annotation function by operating the second button 34B.

The second input apparatus 35 is an apparatus used by the user to draw the drawn image DI on the projection receiving surface PF. As an example, the second input apparatus 35 is an electronic pen used by the user on the projection receiving surface PF. When the user moves the tip of the second input apparatus 35 on the projection receiving surface PF, the drawing unit 328, which will be described later, generates the drawn image DI according to the trajectory of the tip of the second input apparatus 35. The drawn image DI is displayed on the projection receiving surface PF.

The communication apparatus 36 is hardware serving as a transmission and reception device to communicate with other apparatuses. The communication apparatus 36 is also called, for example, a network device, a network controller, a network card, or a communication module. The communication apparatus 36 may include a connector for wired connection and an interface circuit corresponding to the connector. The communication apparatus 36 may include a wireless communication interface. Examples of the connector for wired connection and the interface circuit may include those that conform to a wired LAN, IEEE 1394, and USB. Examples of the wireless communication interface may include those that conform to a wireless LAN, Bluetooth (registered trademark), and the like.

The processing apparatus 32A reads the control program PR3A from the storage apparatus 33A and executes the program to function as a communication control unit 321A, a first acquisition unit 322, a projection control unit 323, a second acquisition unit 324A, a first acceptance unit 325, a third acquisition unit 326A, a second acceptance unit 327, and a drawing unit 328. Note that the control program PR3A may be transmitted from another apparatus such as the information terminal apparatus 10A, which manages the display apparatus 30A, via the communication network NET.

The communication control unit 321A controls the communication apparatus 36 to cause the communication apparatus 36 to transmit and receive various pieces of information, data, and signals to and from external apparatuses. The external apparatuses include the information terminal apparatus 10A.

The first acquisition unit 322 acquires the projection image PP to be projected onto the projection receiving surface PF. As an example, the first acquisition unit 322 acquires the acquired image described above from the information terminal apparatus 10A as the projection image PP. The acquired image includes the video MV. As another example, the first acquisition unit 322 acquires the projection image PP from the storage apparatus 33A.

The projection control unit 323 causes the projector 31 to project the projection image PP acquired by the first acquisition unit 322 onto the projection receiving surface PF. The projection image PP includes the video MV.

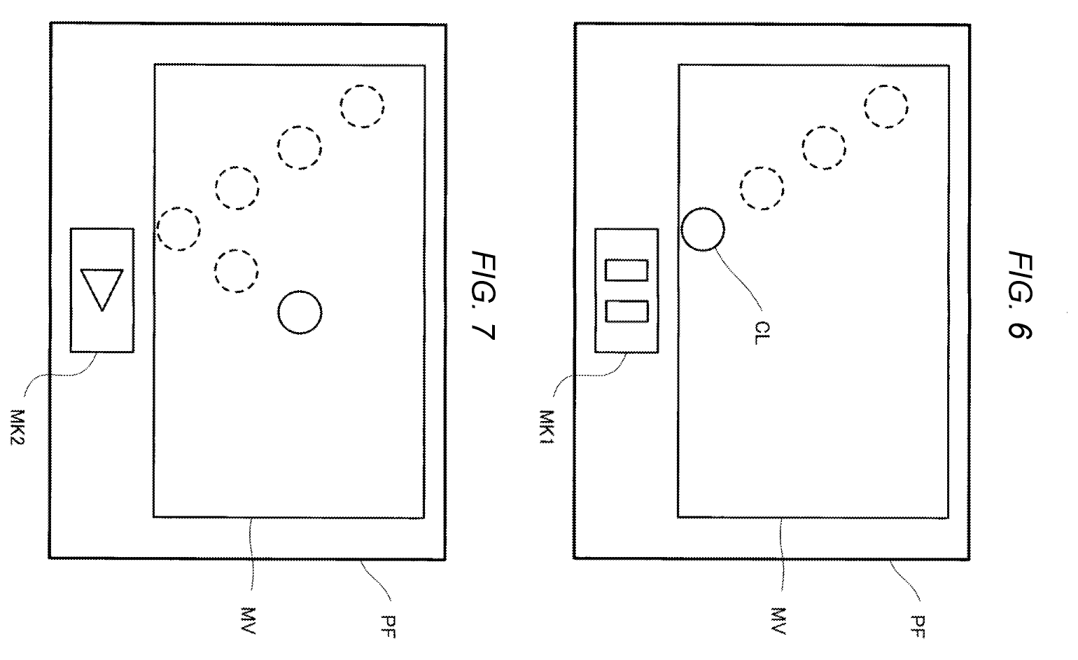

FIG. 6 shows an example of an image displayed on the projection receiving surface PF. In the example shown in FIG. 6, a video MV showing a moving circle CL is displayed on the projection receiving surface PF. On the projection receiving surface PF, a mark MK1 indicating that the annotation function is kept stopped is displayed below the video MV.

In FIG. 4, the second acquisition unit 324A acquires the shortcut key group corresponding to the activated application AP from the information terminal apparatus 10A. The second acquisition unit 324A stores the acquired shortcut key group in the storage apparatus 33A. In the example described above, the second acquisition unit 324A stores, in the storage apparatus 33A, information indicating "Enter" as the first shortcut key corresponding to the first application AP1 and information indicating "Space" as the second shortcut key corresponding thereto.

The first acceptance unit 325 accepts the start signal of the annotation function or the stop signal of the annotation function from the first input apparatus 34.

The third acquisition unit 326A acquires the first shortcut key or the second shortcut key from the storage apparatus 33A. Specifically, the third acquisition unit 326A acquires the information indicating the first shortcut key in response to a trigger indicating that the first acceptance unit 325 has accepted the start signal of the annotation function. The third acquisition unit 326A acquires the information indicating the second shortcut key in response to a trigger indicating that the first acceptance unit 325 has accepted the stop signal of the annotation function.

In the example described above, when the first acceptance unit 325 accepts the start signal of the annotation function, the third acquisition unit 326A acquires the information indicating a shortcut key "Enter" as the first shortcut key. When the first acceptance unit 325 accepts the stop signal of the annotation function, the third acquisition unit 326A acquires the information indicating a shortcut key "Space" as the second shortcut key.

The information indicating the first shortcut key or the information indicating the second shortcut key acquired by the third acquisition unit 326A is transmitted to the information terminal apparatus 10A by the communication control unit 321A. The video control unit 116 provided in the information terminal apparatus 10A controls the reproduction of the video MV based on the information indicating the first shortcut key or the information indicating the second shortcut key received from the display apparatus 30A.

As an example, when the information indicating the first shortcut key or the information indicating the second shortcut key acquired by the third acquisition unit 326A is received by the communication apparatus 15 of the information terminal apparatus 10A, and the received information is inputted to the input apparatus 14, the video control unit 116 acquires input information corresponding to the information via the input apparatus 14. The video control unit 116 then controls the reproduction of the video MV based on the input information.

As another example, when the information indicating the first shortcut key or the information indicating the second shortcut key acquired by the third acquisition unit 326A is received by the communication apparatus 15 of the information terminal apparatus 10A, and the received information is directly inputted to the processing apparatus 11A, the video control unit 116 controls the reproduction of the video MV based on the input information.

In the example described above, when the input information from the input apparatus 14 or the communication apparatus 15 is "Enter", the video control unit 116 pauses the reproduction of the video MV. When the input information from the input apparatus 14 or the communication apparatus 15 is "Space", the video control unit 116 resumes the reproduction of the video MV.

FIG. 7 shows an example of an image displayed on the projection receiving surface PF when the first acceptance unit 325 accepts the start signal of the annotation function. In the example shown in FIG. 7, the video MV at a point in time after the point in time in FIG. 6 is displayed on the projection receiving surface PF. On the projection receiving surface PF, a mark MK2 indicating that the annotation function has been started is displayed below the video MV.

In FIG. 4, under the condition that the annotation function is enabled, the second acceptance unit 327 accepts, from the second input apparatus 35, an operation signal generated based on an operation performed on the second input apparatus 35. The operation signal is, as an example, a signal indicating the trajectory of the tip of the second input apparatus 35 on the projection receiving surface PF.

The drawing unit 328 generates the drawn image DI based on the operation signal accepted by the second acceptance unit 327. As an example, the drawn image DI is a linear image that coincides with the trajectory of the tip of the second input apparatus 35 on the projection receiving surface PF.

The projection control unit 323 causes the projector 31 to project the drawn image DI generated by the drawing unit 328 as the projection image PP onto the projection receiving surface PF.

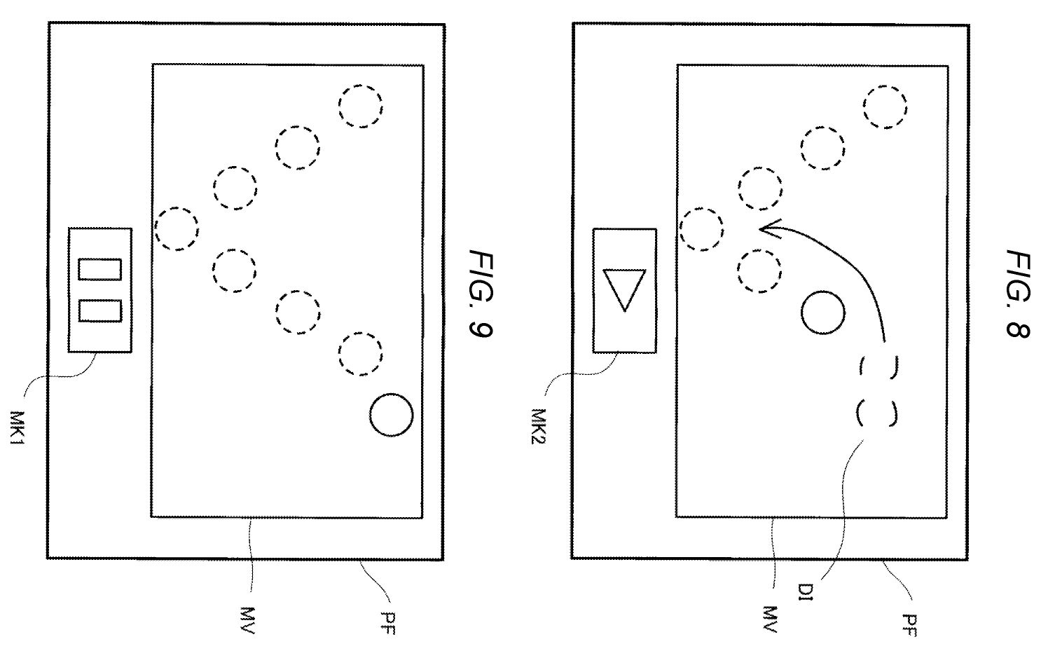

FIG. 8 shows an example of an image displayed on the projection receiving surface PF when the second acceptance unit 327 accepts the operation signal. In the example shown in FIG. 8, the video MV and the drawn image DI at a point in time after the point in time in FIG. 7 is superimposed on each other and displayed on the projection receiving surface PF. On the projection receiving surface PF, the mark MK2 indicating that the annotation function is enabled is displayed below the video MV.

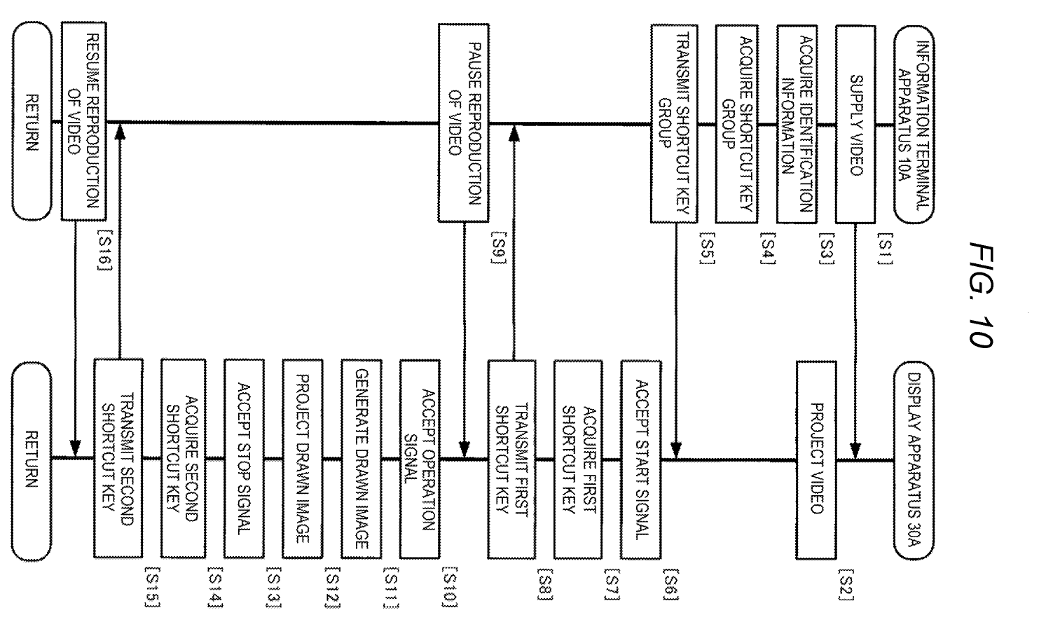

FIG. 9 shows an example of an image displayed on the projection receiving surface PF when the first acceptance unit 325 accepts the stop signal of the annotation function at a point in time after the point in time in FIG. 8. In the example shown in FIG. 9, the video MV at a point in time after the point in time in FIG. 8 is displayed on the projection receiving surface PF. In the example shown in FIG. 9, the drawn image DI displayed in FIG. 8 has been deleted. This is because the projection control unit 323 stops the projection of the drawn image DI onto the projection receiving surface PF in response to a trigger indicating that the first acceptance unit 325 has accepted the stop signal of the annotation function. On the projection receiving surface PF, the mark MK1 indicating that the annotation function has been stopped is displayed below the video MV.

Note in the example shown in FIG. 9 that the drawn image DI displayed in FIG. 8 has been deleted, but this is merely an example, and the drawn image DI may not be deleted.

In the related art, the user invokes the annotation function as appropriate while viewing the video MV being reproduced on the projection receiving surface PF, and draws the drawn image DI to add it to a specific shot of the video MV. In this case, in the first step, the user operates the input apparatus 14 of the information terminal apparatus 10A to pause the reproduction of the video MV. In the second step, the user operates the display apparatus 30A to start the annotation function and draw the drawn image DI to add it to the video MV. In the third step, the user operates the display apparatus 30A to stop the annotation function. In the fourth step, the user operates the information terminal apparatus 10A to resume the reproduction of the video MV.

However, since the display system 1A according to the present embodiment has the configuration in which the application AP installed in the information terminal apparatus 10A is controlled from the display apparatus 30A, the user does not need to execute the second and fourth steps described above. Therefore, in the present embodiment, the user can operate the information terminal apparatus 10A with reduced time and effort.

Furthermore, the first application AP1 and the second application AP2 are installed in the information terminal apparatus 10A, and shortcut keys used to control the reproduction of the video MV differ from each other in the two applications AP. In the display system 1A according to the present embodiment, the display apparatus 30A can uniformly control the reproduction of the video MV in the first application AP1 and the reproduction of the video MV in the second application AP2.

### 1-2: Operation in first embodiment

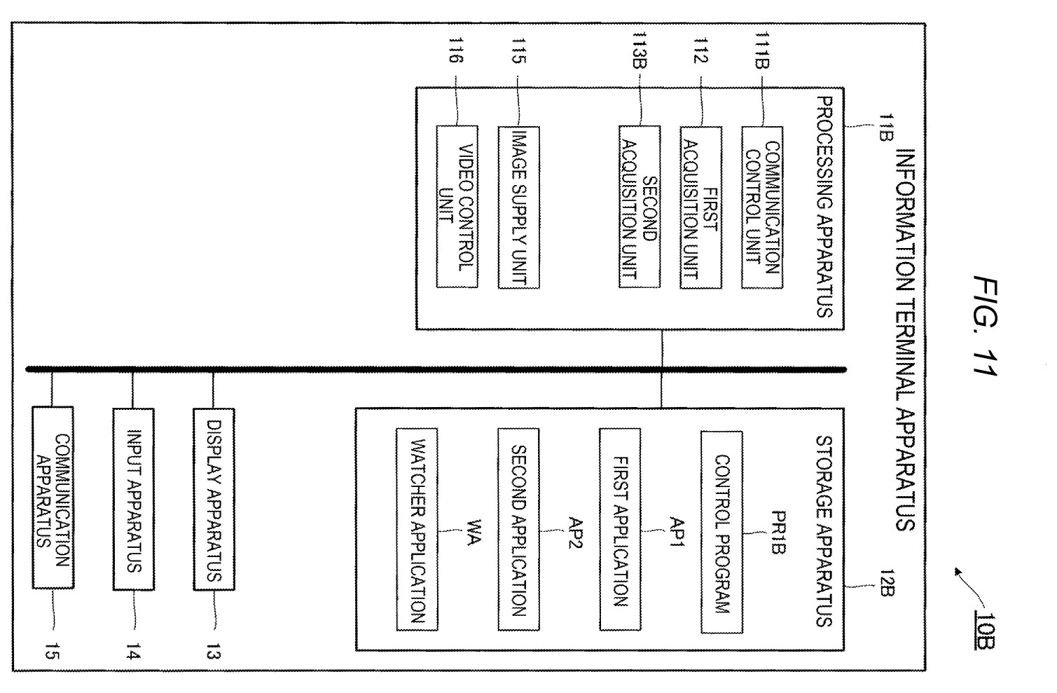

FIG. 10 is a sequence diagram showing the operation of the display system 1A according to the first embodiment.

In step S1, the processing apparatus 11A provided in the information terminal apparatus 10A functions as the image supply unit 115. The processing apparatus 11A supplies the display apparatus 30A with video data indicating the video MV.

The processing apparatus 32A provided in the display apparatus 30A functions as the first acquisition unit 322. The processing apparatus 32A acquires the video data indicating the video MV from the information terminal apparatus 10A.

In step S2, the processing apparatus 32A functions as the projection control unit 323. The processing apparatus 32A causes the projector 31 to project the video MV indicated by the video data acquired in step S1 onto the projection receiving surface PF.

In step S3, the processing apparatus 11A functions as the second acquisition unit 113A. The processing apparatus 11A acquires the identification information of the activated application AP from the watcher application WA.

In step S4, the processing apparatus 11A functions as the third acquisition unit 114. The processing apparatus 11A refers to the shortcut key database SDB by using the identification information acquired in step S3 to acquire a shortcut key group corresponding to the identification information.

In step S5, the processing apparatus 11A functions as the communication control unit 111A. The processing apparatus 11A transmits the shortcut key group acquired in step S4 to the display apparatus 30A.

The processing apparatus 32A functions as the second acquisition unit 324A. The processing apparatus 32A acquires the shortcut key group from the information terminal apparatus 10A. The processing apparatus 32A stores the acquired shortcut key group in the storage apparatus 33A.

In step S6, the processing apparatus 32A functions as the first acceptance unit 325. The processing apparatus 32A accepts the start signal of the annotation function from the first input apparatus 34.

In step S7, the processing apparatus 32A functions as the third acquisition unit 326A. In step S6, the processing apparatus 32A acquires information indicating the first shortcut key from the storage apparatus 33A in response to a trigger indicating that the processing apparatus 32A has accepted the start signal of the annotation function.

In step S8, the processing apparatus 32A functions as the communication control unit 321A. The processing apparatus 32A transmits the information indicating the first shortcut key acquired in step S7 to the information terminal apparatus 10A.

The processing apparatus 11A functions as the communication control unit 111A. The processing apparatus 11A receives the information indicating the first shortcut key from the display apparatus 30A.

In step S9, the processing apparatus 11A functions as the video control unit 116. The processing apparatus 11A pauses the reproduction of the video MV based on the information indicating the first shortcut key received in step S8.

In step S10, the processing apparatus 32A functions as the second acceptance unit 327. The processing apparatus 32A accepts, from the second input apparatus 35, an operation signal generated based on an operation performed on the second input apparatus 35.

In step S11, the processing apparatus 32A functions as the drawing unit 328. The processing apparatus 32A generates the drawn image DI based on the operation signal accepted in step S10.

In step S12, the processing apparatus 32A functions as the projection control unit 323. The processing apparatus 32A causes the projector 31 to project the drawn image DI generated in step S11 as the projection image PP.

In step S13, the processing apparatus 32A functions as the first acceptance unit 325. The processing apparatus 32A accepts the stop signal of the annotation function from the first input apparatus 34.

In step S14, the processing apparatus 32A functions as the third acquisition unit 326A. In step S13, the processing apparatus 32A acquires information indicating the second shortcut key from the storage apparatus 33A in response to a trigger indicating that the processing apparatus 32A has accepted the stop signal of the annotation function.

In step S15, the processing apparatus 32A functions as the communication control unit 321A. The processing apparatus 32A transmits the information indicating the second shortcut key acquired in step S14 to the information terminal apparatus 10A.

The processing apparatus 11A functions as the communication control unit 111A. The processing apparatus 11A receives the information indicating the second shortcut key from the display apparatus 30A.

In step S16, the processing apparatus 11A functions as the video control unit 116. The processing apparatus 11A resumes the reproduction of the video MV based on the information indicating the second shortcut key received in step S15.

### 2: Second embodiment

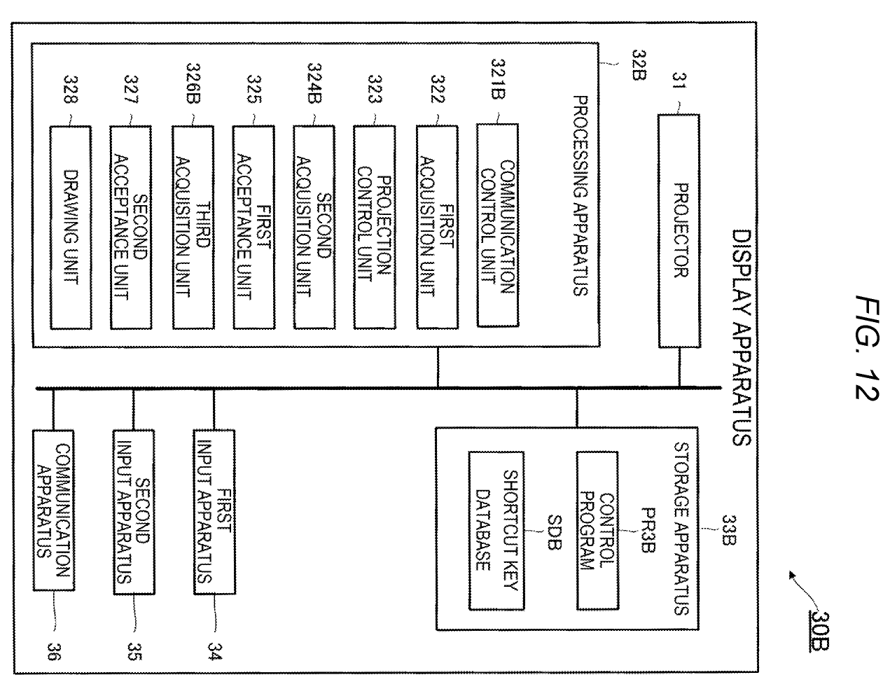

A display system 1B according to a second embodiment will be described below with reference to FIGS. 11 to 13. To simplify the description, differences of the display system 1B according to the present embodiment from the display system 1A according to the first embodiment will be primarily described below. Out of elements provided in the display system 1B, the same elements provided in the display system 1A have the same reference characters, and the description of the functions of the same elements may be omitted.

In the display system 1A according to the first embodiment, the information terminal apparatus 10A includes the shortcut key database SDB. In contrast, in the display system 1B according to the present embodiment, an information terminal apparatus 10B, which will be described later, does not include the shortcut key database SDB, but a display apparatus 30B, which will be described later, includes the shortcut key database SDB.

### 2-1: Configuration of second embodiment

### 2-1-1: Overall configuration

The display system 1B according to the present embodiment includes the information terminal apparatus 10B in place of the information terminal apparatus 10A and the display apparatus 30B in place of the display apparatus 30A, as compared with the display system 1A according to the first embodiment. In other respects, the overall configuration of the display system 1B is the same as the overall configuration of the display system 1A according to the first embodiment, and is therefore not shown.

### 2-1-2: Configuration of information terminal apparatus

FIG. 11 is a block diagram showing an example of the configuration of the information terminal apparatus 10B. Comparison between the example of the configuration of the information terminal apparatus 10B shown in FIG. 11 and the example of the configuration of the information terminal apparatus 10A according to the first embodiment shown in FIG. 2 shows that the information terminal apparatus 10B differs from the information terminal apparatus 10A in that the processing apparatus 11A is replaced with a processing apparatus 11B and the storage apparatus 12A is replaced with a storage apparatus 12B.

The storage apparatus 12B differs from the storage apparatus 12A in that the shortcut key database SDB is not an essential element. The storage apparatus 12B stores a control program PR1B in place of the control program PR1A stored in the storage apparatus 12A.

The processing apparatus 11B reads the control program PR1B from the storage apparatus 12B and executes the program to function as a communication control unit 111B, the first acquisition unit 112, a second acquisition unit 113B, the image supply unit 115, and the video control unit 116. That is, unlike the processing apparatus 11A according to the first embodiment, the processing apparatus 11B does not include the third acquisition unit 114 as an essential element.

The second acquisition unit 113B acquires the identification information of the activated application AP from the watcher application WA, as the second acquisition unit 113A provided in the processing apparatus 11A.

The identification information acquired by the second acquisition unit 113B is transmitted to the display apparatus 30B by the communication control unit 111B.

Specifically, the communication control unit 111B transmits the identification information of the first application AP1 to the display apparatus 30B during the period for which the first application AP1 is kept activated.

Similarly, the communication control unit 111B transmits the identification information of the second application AP2 to the display apparatus 30B during the period for which the second application AP2 is kept activated.

### 2-1-3: Configuration of display apparatus

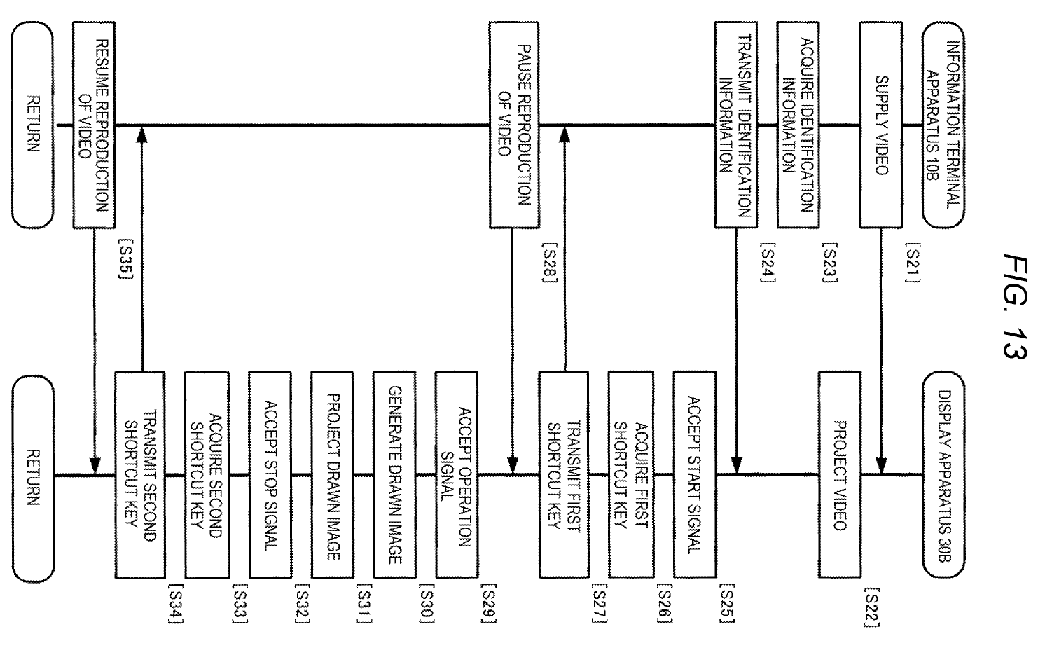

FIG. 12 is a block diagram showing an example of the configuration of the display apparatus 30B. Comparison between the example of the configuration of the display apparatus 30B shown in FIG. 12 and the example of the configuration of the display apparatus 30A according to the first embodiment shown in FIG. 4 shows that the display apparatus 30B differs from the display apparatus 30A in that the processing apparatus 32A is replaced with a processing apparatus 32B and the storage apparatus 33A is replaced with a storage apparatus 33B.

The storage apparatus 33B differs from the storage apparatus 33A in that the shortcut key database SDB is stored. The shortcut key database SDB is the same as the shortcut key database SDB stored in the storage apparatus 12A of the information terminal apparatus 10A in the first embodiment. The storage apparatus 33B stores a control program PR3B in place of the control program PR3A stored in the storage apparatus 33A.

The processing apparatus 32B reads the control program PR3B from the storage apparatus 33B and executes the program to function as a communication control unit 321B, the first acquisition unit 322, the projection control unit 323, a second acquisition unit 324B, the first acceptance unit 325, a third acquisition unit 326B, the second acceptance unit 327, and the drawing unit 328. Note that the control program PR3B may be transmitted from another apparatus such as the information terminal apparatus 10B, which manages the display apparatus 30B, via the communication network NET.

The communication control unit 321B controls the communication apparatus 36 to cause the communication apparatus 36 to transmit and receive various types of information, data, and signals to and from external apparatuses, as the communication control unit 321A provided in the processing apparatus 32A. The external apparatuses include the information terminal apparatus 10B.

The communication control unit 321B further controls the communication apparatus 36 to cause the communication apparatus 36 to receive the shortcut key data SD from the information terminal apparatus 10B. The communication control unit 321B stores the received shortcut key data SD in the shortcut key database SDB.

As an example, in the information terminal apparatus 10B, during the period for which the first application AP1 is kept activated, the communication control unit 321B receives the shortcut key data SD related to the first application AP1 from the information terminal apparatus 10B, and stores the received shortcut key data SD in the shortcut key database SDB. Furthermore, in the information terminal apparatus 10B, during the period for which the second application AP2 is kept activated, the communication control unit 321B receives the shortcut key data SD related to the second application AP2 from the information terminal apparatus 10B, and stores the received shortcut key data SD in the shortcut key database SDB.

The second acquisition unit 324B acquires identification information corresponding to the activated application AP from the information terminal apparatus 10B. As described above, the storage apparatus 33B stores the shortcut key database SDB, and the shortcut key database SDB stores the shortcut key data SD. The shortcut key data SD each contain the following items: "identification information"; "first shortcut key"; and "second shortcut key". Therefore, in the present embodiment, the second acquisition unit 324B acquiring the identification information from the information terminal apparatus 10B is equivalent to the second acquisition unit 324B acquiring a shortcut key group corresponding to the identification information stored in the storage apparatus 33B.

The third acquisition unit 326B acquires the first shortcut key or the second shortcut key from the storage apparatus 33B. Specifically, in response to a trigger indicating that the first acceptance unit 325 has accepted the start signal of the annotation function, the third acquisition unit 326B refers to the shortcut key database SDB by using the identification information acquired by the second acquisition unit 324B to acquire information indicating the first shortcut key. In response to a trigger indicating that the first acceptance unit 325 has accepted the stop signal of the annotation function, the third acquisition unit 326B refers to the shortcut key database SDB by using the identification information acquired by the second acquisition unit 324B to acquire information indicating the second shortcut key.

### 2-2: Operation in second embodiment

FIG. 13 is a sequence diagram showing the operation of the display system 1B according to the second embodiment.

In step S21, the processing apparatus 11B provided in the information terminal apparatus 10B functions as the image supply unit 115. The processing apparatus 11B supplies the display apparatus 30B with video data indicating the video MV.

The processing apparatus 32B provided in the display apparatus 30B functions as the first acquisition unit 322. The processing apparatus 32B acquires the video data indicating the video MV from the information terminal apparatus 10B.

In step S22, the processing apparatus 32B functions as the projection control unit 323. The processing apparatus 32B causes the projector 31 to project the video MV indicated by the video data acquired in step S21 onto the projection receiving surface PF.

In step S23, the processing apparatus 11B functions as the second acquisition unit 113B. The processing apparatus 11B acquires the identification information of the activated application AP from the watcher application WA.

In step S24, the processing apparatus 11B functions as the communication control unit 111B. The processing apparatus 11B transmits the identification information acquired in step S23 to the display apparatus 30B.

The processing apparatus 32B functions as the second acquisition unit 324B. The processing apparatus 32B acquires the identification information from the information terminal apparatus 10B.

In step S25, the processing apparatus 32B functions as the first acceptance unit 325. The processing apparatus 32B accepts the start signal of the annotation function from the first input apparatus 34.

In step S26, the processing apparatus 32B functions as the third acquisition unit 326B. The processing apparatus 32B refers to the shortcut key database SDB by using the identification information acquired in step S24 in response to a trigger indicating that it has accepted the start signal of the annotation function in step S25 to acquire the first shortcut key.

In step S27, the processing apparatus 32B functions as the communication control unit 321B. The processing apparatus 32B transmits information indicating the first shortcut key acquired in step S26 to the information terminal apparatus 10B.

The processing apparatus 11B functions as the communication control unit 111B. The processing apparatus 11B receives the information indicating the first shortcut key from the display apparatus 30B.

In step S28, the processing apparatus 11B functions as the video control unit 116. The processing apparatus 11B pauses the reproduction of the video MV based on the information indicating the first shortcut key received in step S27.

In step S29, the processing apparatus 32B functions as the second acceptance unit 327. The processing apparatus 32B accepts, from the second input apparatus 35, an operation signal generated based on an operation performed on the second input apparatus 35.

In step S30, the processing apparatus 32B functions as the drawing unit 328. The processing apparatus 32B generates the drawn image DI based on the operation signal accepted in step S29.

In step S31, the processing apparatus 32B functions as the projection control unit 323. The processing apparatus 32B causes the projector 31 to project the drawn image DI generated in step S30 as the projection image PP.

In step S32, the processing apparatus 32B functions as the first acceptance unit 325. The processing apparatus 32B accepts the stop signal of the annotation function from the first input apparatus 34.

In step S33, the processing apparatus 32B functions as the third acquisition unit 326B. The processing apparatus 32B refers to the shortcut key database SDB by using the identification information acquired in step S24 in response to a trigger indicating that it has accepted the stop signal of the annotation function in step S32 to acquire the second shortcut key.

In step S34, the processing apparatus 32B functions as the communication control unit 321B. The processing apparatus 32B transmits information indicating the second shortcut key acquired in step S33 to the information terminal apparatus 10B.

The processing apparatus 11B functions as the communication control unit 111B. The processing apparatus 11B receives the information indicating the second shortcut key from the display apparatus 30B.

In step S35, the processing apparatus 11B functions as the video control unit 116. The processing apparatus 11B resumes the reproduction of the video MV based on the information indicating the second shortcut key received in step S34.

### 3: Variations

The embodiments described above can be changed in various manners. Specific aspects of the change will be exemplified below. The aspects exemplified below and the aspects shown in the embodiments described above can be combined with each other as appropriate to the extent that no mutual contradiction occurs. Note that, in the variations exemplified below, elements having effects and functions that are the same as those in the embodiments have the reference characters referred to in the above description, and will not be described in detail as appropriate.

### 3-1: Variation 1

In the display system 1A according to the first embodiment, two applications AP, the first application AP1 and the second application AP2, are installed in the information terminal apparatus 10A. The number of the applications AP installed in the information terminal apparatus 10A may instead be one or three or more.

The same applies to the display system 1B according to the second embodiment.

### 3-2: Variation 2

In the display system 1A according to the first embodiment, the shortcut key group corresponding to the first application AP1 includes the first shortcut key used to pause the reproduction of the video MV, and the second shortcut key used to start the reproduction of the video MV. The shortcut key group may, however, include other shortcut keys. For example, the shortcut key group may include shortcut keys used to instruct fast-forwarding the video MV, rewinding the video MV, transition to the next video MV, and rewinding the video MV being reproduced back to the start point.

The same applies to the shortcut key group corresponding to the second application AP2.

The same applies to the display system 1B according to the second embodiment.

### 3-3. Variation 3

In the display system 1A according to the first embodiment, the display apparatus 30A includes two input apparatuses, the first input apparatus 34 and the second input apparatus 35. The display apparatus 30A may, however, include only a single input apparatus. As an example, the first button 34A and the second button 34B, with which the first input apparatus 34 is provided, may be disposed at a surface of an enclosure of the second input apparatus 35 as an electronic pen.

Instead, the second input apparatus 35 as an electronic pen may include a sensor that detects the distance to the projection receiving surface PF, and when the distance becomes smaller than or equal to a threshold set in advance, the start signal of the annotation function may be input from the second input apparatus 35 to the processing apparatus 32A. When the distance becomes greater than the threshold, the stop signal of the annotation function may be input from the second input apparatus 35 to the processing apparatus 32A.

Still instead, when the tip of the second input apparatus 35 comes into contact with the projection receiving surface PF, the start signal of the annotation function may be input from the second input apparatus 35 to the processing apparatus 32A. When the tip gets separated from the projection receiving surface PF, the stop signal of the annotation function may be input from the second input apparatus 35 to the processing apparatus 32A.

Instead, when the tip of the second input apparatus 35 comes into contact with the mark MK1 shown in FIGS. 6 to 9 by way of example, the start signal of the annotation function may be input from the second input apparatus 35 to the processing apparatus 32A. When the tip comes into contact with the mark MK2, the stop signal of the annotation function may be input from the second input apparatus 35 to the processing apparatus 32A.

The same applies to the display system 1B according to the second embodiment.

### 3-4. Variation 4

In the display system 1A according to the first embodiment, the first and second shortcut keys are transmitted from the display apparatus 30A to the information terminal apparatus 10A, and the information terminal apparatus 10A controls an operation related to the reproduction of the video MV and used in the first application AP1 or the second application AP2 based on the first and second shortcut keys received from the display apparatus 30A.

Instead of the first and second shortcut keys, a control signal used to control the operation related to the reproduction of the video MV may be transmitted from the display apparatus 30A to the information terminal apparatus 10A. In this case, the watcher application WA provided in the information terminal apparatus 10A inputs the first and second shortcut keys corresponding to the first application AP1 or the second application AP2 to the processing apparatus 11A based on the control signal.

The same applies to the display system 1B according to the second embodiment.

### 4: Summary of present disclosure

The present disclosure will be summarized below in the form of additional remarks.

(Additional Remark 1) A method for controlling a display system including an information terminal apparatus and a display apparatus configured to communicate with the information terminal apparatus, the method including: transmitting video data from the information terminal apparatus to the display apparatus; projecting a video onto a projection receiving surface via the display apparatus based on the video data; acquiring, via the display apparatus, one or more shortcut keys used to control reproduction of the video, the one or more shortcut keys corresponding to an application configured to control the video in the information terminal apparatus; transmitting any one of the one or more shortcut keys from the display apparatus to the information terminal apparatus; and controlling the video based on the one shortcut key received by the information terminal apparatus.

According to the configuration described above, the information terminal apparatus can control the video on the assumption that the video is reproduced by using various applications.

More specifically, a shortcut key corresponding to an application used in the information terminal apparatus can be transmitted from the display apparatus. The display apparatus can thus control the application on the information terminal apparatus.

(Additional Remark 2) The method for controlling a display system according to Additional Remark 1, the method further including acquiring identification information used to identify the application via the display apparatus, wherein acquiring the one or more shortcut keys via the display apparatus is acquiring the one or more shortcut keys based on the identification information.

According to the configuration described above, the display apparatus acquires the identification information used to identify an application, and acquires one or more shortcut keys based on the identification information to cope with a case where the shortcut key varies on an application basis.

(Additional Remark 3) The method for controlling a display system according to Additional Remark 1, wherein transmitting the one shortcut key from the display apparatus to the information terminal apparatus includes transmitting the one shortcut key from the display apparatus to the information terminal apparatus when the display apparatus accepts an operation of starting or stopping an annotation function of superimposing a drawn image drawn by a user on the video and displaying the superimposed image.

According to the configuration described above, the user's convenience is improved by combining the annotation function and the control of the reproduction of the video.

(Additional Remark 4) The method for controlling a display system according to Additional Remark3, wherein the one or more shortcut keys include at least one of a first shortcut key used to pause the reproduction of the video associated with the start of the annotation function, and a second shortcut key used to start reproduction of the video when the annotation function is stopped.

According to the configuration described above, the start of the annotation function and the pause of the reproduction of the video can be performed in conjunction with the stop of the annotation function and the reproduction of the video.

(Additional Remark 5) The method for controlling a display system according to Additional Remark 3, wherein the display system further includes an electronic pen used for drawing with an aid of the annotation function, and the method includes starting or stopping the annotation function when a button with which the electronic pen is provided is operated.

According to the configuration described above, since the annotation function can be started or stopped by operating the button with which the electronic pen is provided, the user's convenience is improved.

(Additional Remark 6) The method for controlling a display system according to Additional Remark 1, wherein the application is an activated application displayed as a forefront image on the projection receiving surface.

According to the configuration described above, acquiring only an activated shortcut key allows one-to-one association of the shortcut key with a specific button of the display apparatus, so that the user can intuitively operate the shortcut key.

(Additional Remark 7) The method for controlling a display system according to Additional Remark 3, wherein the drawn image is deleted when an operation of stopping the annotation function is accepted.

According to the configuration described above, since the drawn image is deleted when the annotation function is stopped, the user does not need to perform a deletion operation, so that the user's convenience is improved.

(Additional Remark 8) A non-transitory computer-readable storage medium storing a program configured to control a display system including an information terminal apparatus and a display apparatus configured to communicate with the information terminal apparatus, the program causing the information terminal apparatus to transmit video data to the display apparatus; causing the display apparatus to project a video onto a projection receiving surface based on the video data; causing the display apparatus to acquire one or more shortcut keys used to control reproduction of the video, the one or more shortcut keys corresponding to an application configured to control the video in the information terminal apparatus; causing the display apparatus to transmit any one of the one or more shortcut keys to the information terminal apparatus; and causing the information terminal apparatus to control the video based on the received one shortcut key.

According to the configuration described above, the information terminal apparatus can control the video on the assumption that the video is reproduced by using various applications.

More specifically, a shortcut key corresponding to an application used in the information terminal apparatus can be transmitted from the display apparatus. The display apparatus can thus control the application on the information terminal apparatus.

(Additional Remark 9) A display system including an information terminal apparatus and a display apparatus configured to communicate with the information terminal apparatus, wherein the information terminal apparatus includes a communication control unit configured to transmit video data to the display apparatus, the display apparatus includes a projection control unit configured to project a video onto a projection receiving surface based on the video data, the display apparatus includes an acquisition unit configured to acquire one or more shortcut keys used to control reproduction of the video, the one or more shortcut keys corresponding to an application configured to control the video in the information terminal apparatus, the display apparatus includes a communication control unit configured to transmit any one of the one or more shortcut keys acquired by the acquisition unit to the information terminal apparatus, and the information terminal apparatus includes a video control unit configured to control the video based on the one shortcut key received from the display apparatus.

According to the configuration described above, the information terminal apparatus can control the video on the assumption that the video is reproduced by using various applications.

More specifically, a shortcut key corresponding to an application used in the information terminal apparatus can be transmitted from the display apparatus. The display apparatus can thus control the application on the information terminal apparatus.

What is claimed is:

1. A method for controlling a display system including an information terminal apparatus and a display apparatus configured to communicate with the information terminal apparatus, the method comprising:
transmitting video data from the information terminal apparatus to the display apparatus;
projecting a video onto a projection receiving surface via the display apparatus based on the video data;
acquiring, via the display apparatus, one or more shortcut keys used to control reproduction of the video, the one or more shortcut keys corresponding to an application configured to control the video in the information terminal apparatus;
transmitting any one of the one or more shortcut keys from the display apparatus to the information terminal apparatus; and
controlling the video based on the one shortcut key received by the information terminal apparatus.

2. The method for controlling a display system according to claim 1, the method further comprising
acquiring identification information used to identify the application via the display apparatus,
wherein acquiring the one or more shortcut keys via the display apparatus is acquiring the one or more shortcut keys based on the identification information.

3. The method for controlling a display system according to claim 1, wherein
transmitting the one shortcut key from the display apparatus to the information terminal apparatus includes transmitting the one shortcut key from the display apparatus to the information terminal apparatus when the display apparatus accepts an operation of starting or stopping an annotation function of superimposing a drawn image drawn by a user on the video and displaying the superimposed image.

4. The method for controlling a display system according to claim 3, wherein
the one or more shortcut keys include at least one of a first shortcut key used to pause the reproduction of the video associated with the start of the annotation function, and a second shortcut key used to start reproduction of the video when the annotation function is stopped.

5. The method for controlling a display system according to claim 3, wherein
the display system further includes an electronic pen used for drawing with an aid of the annotation function, and
the method comprises starting or stopping the annotation function when a button with which the electronic pen is provided is operated.

6. The method for controlling a display system according to claim 1, wherein
the application is an activated application displayed as a forefront image on the projection receiving surface.

7. The method for controlling a display system according to claim 3, wherein
the drawn image is deleted when an operation of stopping the annotation function is accepted.

8. A non-transitory computer-readable storage medium storing a program configured to control a display system including an information terminal apparatus and a display apparatus configured to communicate with the information terminal apparatus, the program
causing the information terminal apparatus to transmit video data to the display apparatus;
causing the display apparatus to project a video onto a projection receiving surface based on the video data;
causing the display apparatus to acquire one or more shortcut keys used to control reproduction of the video, the one or more shortcut keys corresponding to an application configured to control the video in the information terminal apparatus;
causing the display apparatus to transmit any one of the one or more shortcut keys to the information terminal apparatus; and
causing the information terminal apparatus to control the video based on the received one shortcut key.

9. A display system comprising: an information terminal apparatus; and a display apparatus configured to communicate with the information terminal apparatus, wherein
the information terminal apparatus includes a communication control unit configured to transmit video data to the display apparatus,
the display apparatus includes a projection control unit configured to project a video onto a projection receiving surface based on the video data,
the display apparatus includes an acquisition unit configured to acquire one or more shortcut keys used to control reproduction of the video, the one or more shortcut keys corresponding to an application configured to control the video in the information terminal apparatus,
the display apparatus includes a communication control unit configured to transmit any one of the one or more shortcut keys acquired by the acquisition unit to the information terminal apparatus, and
the information terminal apparatus includes a video control unit configured to control the video based on the one shortcut key received from the display apparatus.
